(19) United States
(12) Patent Application Publication
(10) Pub. No.: US 2026/0162186 A1
(43) Pub. Date: Jun. 11, 2026

(54) USE DIRECT DATA COLLECTION TO ENHANCE HEALTH INSURANCE UNDERWRITING

(71) Applicants: Yaopeng Zhou, New York, NY (US); Mohammad Rahman, Nutley, NJ (US); Jovita Lara Juanillo, Del Mar, CA (US)

(72) Inventors: Yaopeng Zhou, New York, NY (US); Mohammad Rahman, Nutley, NJ (US); Jovita Lara Juanillo, Del Mar, CA (US)

(73) Assignee: Smart Vision Health, INC., New York, NY (US)

(21) Appl. No.: 19/052,383

(22) Filed: Feb. 13, 2025

Related U.S. Application Data
(60) Provisional application No. 63/555,208, filed on Feb. 19, 2024.

(51) Int. Cl. G06Q 40/08; G06F 21/62

(52) U.S. Cl. CPC G06Q 40/082; G06F 21/6254

(57) ABSTRACT

The present invention discloses a computer-implemented system and method for direct, privacy-compliant collection and analysis of health data via a mobile application integrated with trained large language models (LLMs). The system enables individuals to input medical, health, or insurance-related inquiries through a portable computing device, such as a smartphone, where an LLM processes the inquiry to generate context-aware responses and extracts keywords for categorization into predefined medical or insurance risk categories (e.g., cardiovascular disease, pharmacy). User-authorized, anonymized data is securely transmitted to a cloud-based platform, where aggregated datasets are analyzed to generate real-time risk assessments for insurers, employers, or plan administrators. By streamlining direct data collection and LLM-driven analysis, the invention enhances transparency, accuracy, and efficiency in underwriting, stop-loss insurance pricing, and employer-sponsored health plan optimization.

### CROSS REFERENCE TO RELATED APPLICATION

This application claims the benefit of priority of the U.S. Provisional Patent Application No. 63/555,208, filed on Feb. 19, 2024, which is hereby incorporated by reference in its entirety.

### TECHNICAL FIELD

Embodiments of the present disclosure relate to directly collecting permitted and approved raw aggregated health data from a group of employees or members to enhance health insurance underwriting.

### BACKGROUD

The subject matter of this application relates to the systems and methods for medical and health data collection used most typically by health insurance, self-funded employer plans, and stop loss insurance, to select and assess risk, manage risk portfolios, optimize benefit, and improve stop loss plan operational and pricing process. Such medical and health data are invaluable to the underwriting process. The proposed applications allow improved accuracy and transparency for all parties involved in risk evaluation or assessment process, including insurance carriers, employers, and individual employees. Particularly, the subject matter of this application pertains to software or Mobile Device Application, or “Apps'” that are capable of being remotely deployed to a portable computing device, such as smartphone, thereby creating a method to directly collect permitted and approved raw aggregated data from a group of employees or members, without waiting for the same data to be provided by insurance carriers or plan administrators to assess employer aggregated risks. The subject matter of this application utilizes trained large language models to offer answers to medical, health and insurance inquiries initialized by employees or members on their personal portable computing device, and permitted to be shared in aggregate with employer, plan sponsors, or insurers. Individuals can also perform their own risk analysis without sharing it with their employer. Further, the disclosed software method utilizes the portable computing device's internet connectivity to transmit the entire inquiry to a remote computation device, such as a computer cloud. The transmitted inquiry can be classified into key words, and these keywords can be fit into different medical or health categories or sub-categories, such as cancers, cardiovascular disease, musculoskeletal, pharmacy, dental, vision, wellness and others. These key word dataset from a selected group of employees can be interpreted by insurance underwriters, employers or employees.

One objective of the subject matter of this application is to provide a trained large language model that, when deployed to employee or member's personal portable computing devices such as a smartphone, forms an Artificial Intelligence (AI) medical or health advisor. A further objective is to provide a real time data collection method for health risk and stop loss underwriters by analyzing the medical and health inquiries initialized by employees or members. Such a direct data collection process between members and underwriters can provide much enhanced accuracy and transparency of the dataset without distortion and delay. Another objective is to classify these data inquiries into key words. These keywords can be fit into different health categories. These keywords can also be filtered based on potential diagnosis and treatment cost. Health risk and stop loss underwriters can predict future claims based on the inquiry data trend and cost trend. Another objective is to provide a de-identified process in the data collection. The collected medical inquiries are not associated with the individual employee or member, but only associated with the identity of the group. The said group typically has 100 members or more in headcount. Furthermore, permitted and approved by employers, and employees or members, the directly collected real time data combined with historical health data provided by third party providers, such as medical, pharmacy, dental, vision, wellness and behavioral health, can show a full storyline of of the health risk profile of the group from the past to the future.

These objectives can be obtained by a trained large language model that can be remotely deployed to a mobile computing device (the “mobile device”), such as smartphone, personal digital assistant, laptop or palmtop computer. Smartphones are mobile phones composing a computer and internet connectivity among other features. The trained large language model after installed on smartphones, or other devices, can provide answers to medical, health and insurance inquiries initialized by individual employees or members. The trained large language model can be a combination or selection of a large language model, specifically tailored language model trained on insurance policy, claim data and de-identified medical records associated with the selected insured group, and medical language model trained on up to date medical data, literature and standard medical practices. The App can provide reasonably accurate answers to the medical, health and insurance inquiries initialized by employees or members during their initial research phase when they encounter symptoms and diseases. The mobile devices can transmit the health, medical and insurance inquiries to the computer cloud for further processing.

In the current practice, group medical insurance or stop loss underwriters can acquire de-identified medical history data about the the group from provider group (i.e. hospitals or physician groups) , insurance carriers, claim clearing warehouse, or third party data company. However, there are two drawbacks in the current practice:
1. The data is outdated. Almost all employer aggregated health data from insurers or plan administrators are provided 3-6 months old, if shared or available. Some are not even provided which avoids transparency in risk assessment or in validating whether the pricing of an employer or individual's risk was accurate in the first place. This invention allows employers and individuals to assess their own company or individual's health insurance pricing risk with greater accuracy and transparency. For example, It can be tremendously expensive for hospitalization to have a premature baby. Due to the nature of the data collection, there is no indication that such a cost can occur from looking into historical medical data.
2. The data can be inaccurate, or not enough detail to be helpful. Third party data companies acquire data from filtering public data available on the web. There is no guarantee on the source of accuracy, or the representation accuracy. Data from hospitals or insurance carriers typically lack details on purpose.

In contrast with the current practice of health risk underwriters using to acquire data, In this invention, we propose a new data collection method to provide real time medical and health data. With the trained large language model, the AI software is able to provide an accurate answer to users for medical, health and insurance inquiries. We propose to deploy such a trained large language model software directly to a group of employees or members.

Traditionally, when an employee or member is sick or needs medical or health information, he or she will search the web to read through dozens of articles associated with keywords. The employee or member will form his or her unique understanding on the topic. A trained large language model is able to accurately respond to the inquiry with the best answer and allow employees or members to quickly read through on a single answer to understand the topic.

When such a trained large language model is also trained on the insurance policy information, the employee can research insurance approval criteria on complex and expensive medications and medical procedures.

When a group of the employees interact with such a trained large language model, the inquiry terms are a reflection of the current “population health” for the selected group. When the group inquiry terms are organized and presented in a daily, monthly and yearly fashion, i.e., Over 6 months, 12 months, 24 months, or longer periods of time, the health risk and stop loss underwriters can readily identify the most prevalent health concerns or conditions among the group.

By using AI, the data collection system can also differentiate the high cost items associated with treatments required for complex health or medical conditions. For example, when “pregnancy” and “premature” appear in the data collection, it represents a higher possibility of hospitalization for the premature birth.

Such a collection data system can help group medical insurance, self-funded employer plans and stop loss insurance carriers to understand the future risk. More importantly, such data collection is conducted directly from the end users—employees and members. There are no middle layers to distort the accuracy of the data.

Such data can be made available to insurance carriers, employers and employees. It brings more transparency to the current healthcare system. Employers are able to have confidence in their healthcare budget, and adjust the budget based on inquiry data.

### BRIEF DESCRIPTION OF THE ILLUSTRATIONS

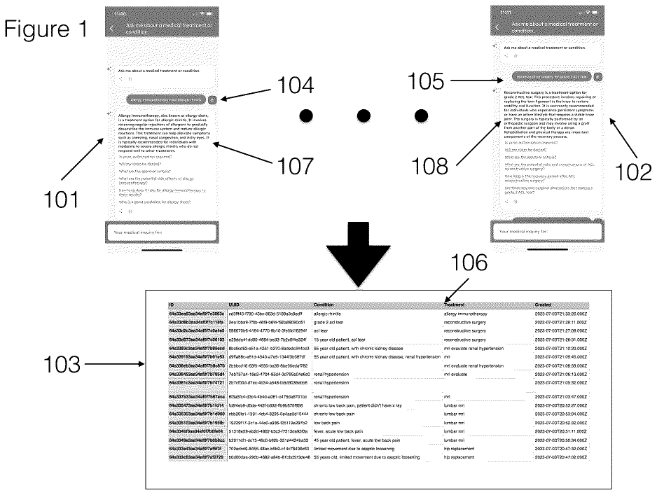

FIG. 1 depicts a schematic of the disclosed medical and health inquiry data collection platform.

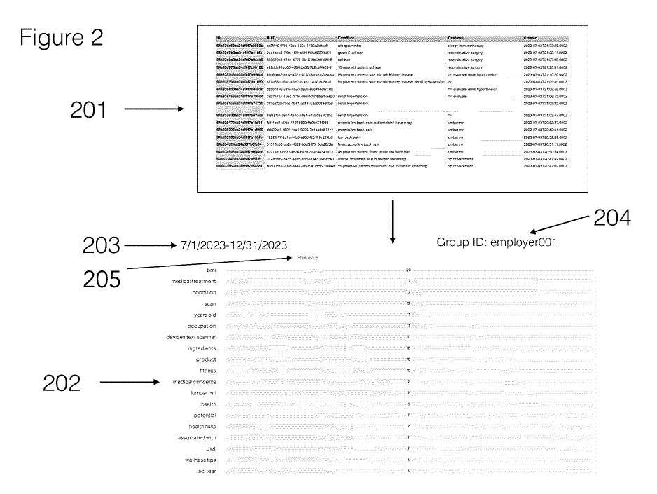

FIG. 2 illustrates key words distilled from the medical and health inquiries. Ranking the key words based on appearance frequency can show the medical and health trend among the selected group of employees.

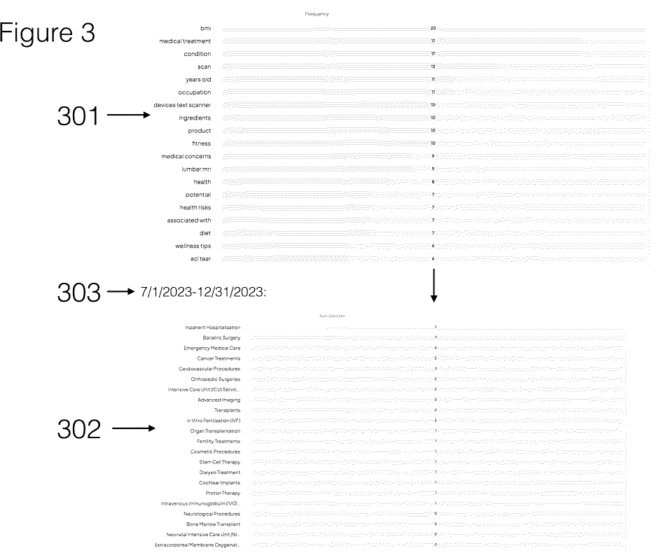

FIG. 3 depicts high cost treatments based on the medical and health key words of the selected group.

### DETAILED DESCRIPTION OF THE ILLUSTRATIONS

The following description and drawings referenced therein illustrate an embodiment of the application's subject matter. They are not intended to limit the scope. Those familiar with the art will recognize that other embodiments of the disclosed method are possible. All such alternative embodiments should be considered within the scope of the application's claims.

Each reference number consists of three digits. The first digit corresponds to the figure number in which that reference number is first shown. Reference numbers are not necessarily discussed in the order of their appearance in the figures.

This application discloses a medical and health data collection method, when deployed to a selected group of employees or members, can be used by group medical insurance, self-funded employer plans and stop loss insurance underwriters, to select and assess risk, manage risk portfolios and optimize benefit and pricing process. The mobile computing device (the “mobile device”) is most commonly a smartphone equipped with a computer and internet connectivity, although other devices such as tablet computers, laptop computers, certain audio or video players, and ebook readers can also be used, as long as these devices comprise a central processing unit or a way of communicating information to another device comprising a central processing unit. This manner of utilizing certain mobile devices already commonly owned, reduces the cost associated with distributing the data collection method.

FIG. 1 depicts a simple overview of an aspect of a preferred embodiment of the subject matter of this application in which mobile devices (101 and 102) owned by a group of selected employees or members, installed with trained large language model, can provide answers to medical, health and insurance inquires initialized by individual employee or member. The selected group typically has 100 members or more. In FIG. 1, “allergy immunotherapy treat allergic rhinitis” (104) and “reconstructive surgery for grade 2 ACL tear” (105) are two inquiries initialized by individuals in the selected group. The trained large language model can provide accurate answers (107 and 108) to these inquiries. These inquiries initialized by employees or members are sent to a remote device (103) that comprises a central processing unit, i.e., cloud computers. These inquiries (106) can be a single word, or multiple sentences or paragraphs describing conditions or treatments related to medical or health nature. These inquiries can also be questions related to insurance approval or denial criteria on certain medical procedures and medications.

An identification number, “Group ID: employer001” (204), can be created to be associated with the selected group, shown in FIG. 2. The medical and health inquiries along with associated group identification numbers can be transmitted to cloud computers. No individual employee or member identification may be disclosed during transmission to protect the employees'or members'privacy. These medical and health inquiries represent the characteristics and trends of the selected group, not individual.

The medical and health inquiries transmitted to cloud computers are a reflection of current affairs or topics initialized by the selected group of individuals. These inquiries qualitatively and quantitatively represent the trend of medical or health conditions of the selected group, which health risk and stop loss insurance underwriters can use to select and assess risk, manage risk portfolios and optimize benefit and pricing process.

Cloud computers can also further process the received medical and health inquiries (201) into keywords (202) based on different medical and health categories or sub-categories, such as weight loss, diabetes, cancers, cardiovascular, musculoskeletal and so on. Grouping and ranking these keywords (202) received during a fix amount of time, “7/1/2023-12/31/2023” (203, 303, i. e, one day, one week, one month, 12 months or longer period of time) can further clarify the trend of the selected group. The Frequency (205) shows the number of appearances of the keywords (202) in the predefined time period (203).

FIG. 3 illustrates that the ranked keywords (301) can be categorized (302) based on the cost of the treatments associated with the keywords (301) in the cloud computers. High cost treatments have a bigger impact in determining the premiums of the health insurance and stop loss insurance. For example, treatments of lung cancer, in the range of a few hundred thousands dollars, can have a much bigger impact on the insurance premium than that of a routine treatment of strep throat, in the range of a few hundred dollars. Such a grouping based on treatment costs provide valuable information, related to the selected group risk profile, to health risk and stop loss insurance underwriters.

What is claimed is:

1. A method for collecting and processing medical and health data, comprising:
Installing trained large language models on one or more mobile computing devices, the large language models being capable of processing and providing answers to inquiries related to medical, health, and health insurance topics, wherein the mobile computing devices are owned by a select group of employees or members;
Receiving medical and health inquiries initiated by individual employees or members within the selected group, wherein each inquiry pertains to at least one of medical, health, or health insurance information, and transmitting the inquiries to a remote computing device over a communication network, the communication network including at least one of cellular, Wi-Fi, or other internet-based protocols;
Assigning a unique group identification number to the selected group of employees or members, wherein the group identification number is used to associate the transmitted medical and health inquiries with the selected group, while maintaining anonymity of individual member within the group for privacy protection;
Processing and filtering the transmitted medical and health inquiries on the remote computing device by extracting keywords from the inquiries, the extracted keywords being classified into a plurality of medical and health categories or sub-categories, wherein the categories include, but are not limited to, diseases, treatments, preventive care, pharmacy, dental, vision, wellness and healthcare plans;
Ranking the occurrence frequency of each keyword over a predefined time period, wherein the ranking is used to identify emerging medical and health trends or patterns within the selected group, with the ranking based on at least one of the number of occurrences of each keyword, the relevance of the keyword, or the urgency of the medical or health issue indicated by the keyword;
Categorizing medical treatments associated with the extracted keywords based on cost information, wherein the categorization includes grouping treatments into cost tiers or ranges, thereby enabling cost comparisons between different medical treatments for the same or similar conditions;
Generating a report based on the processed data, wherein the report includes one or more of the following: a summary of the identified medical and health trends, a cost comparison for medical treatments, and a predictive analysis of future medical needs or healthcare expenses for the selected group, the report being delivered to a designated recipient selected from the group consisting of insurers, employers, plan sponsors, or the employees/members themselves.

2. The method of claim 1, wherein the large language models are specifically trained to recognize and provide responses to inquiries about one or more of the following: chronic conditions, preventative care strategies, healthcare plan options, prescription medications, or insurance coverage and claims processes.

3. The method of claim 1, further comprising the step of providing real-time feedback to individual employees or members based on their inquiries, wherein the feedback includes at least one of personalized recommendations for improving health, advice for navigating health insurance options, or guidance on managing healthcare expenses.

4. The method of claim 1, wherein the privacy of individual employee or member is preserved by anonymizing any personal identifiable information (PII) prior to transmission to the remote computing device, such that only aggregated data is used in the analysis and reporting process, and no personally identifiable data is disclosed to third parties without explicit consent.

5. The method of claim 1, wherein the remote computing device is a cloud-based computing platform capable of processing a large volume of data from multiple mobile computing devices, the cloud-based platform being configured to scale dynamically based on the volume of incoming medical and health inquiries, and to ensure high availability and reliability of the service.

6. The method of claim 1, wherein the categorization of medical treatments based on cost is further refined by considering at least one of the following: regional cost variations, insurance plan reimbursement rates, out-of-pocket cost estimates, or historical data regarding treatment outcomes and associated healthcare expenditures.

7. The method of claim 1, wherein the group identification number is stored in an encrypted format on the mobile computing device, and access to the data associated with the group identification number is controlled through multi-factor authentication mechanisms to prevent unauthorized access to the medical and health inquiries and trends data.

8. The method of claim 1, wherein the medical and health inquiries are further analyzed to identify patterns related to specific demographics within the selected group, such as age, gender, or job role, thereby providing targeted insights for different subsets of the group regarding health risks, insurance needs, and treatment preferences.

9. The method of claim 1, further comprising the step of alerting designated recipients when certain medical or health inquiries exceed a predefined threshold for urgency, wherein the alert is based on keywords indicating high-priority health conditions or insurance coverage issues, and includes a recommended course of action for the recipient.

10. The method of claim 1, wherein the medical and health inquiries are categorized into one or more sub-categories based on the severity or urgency of the health condition indicated by the keyword, wherein high-severity or high-urgency issues are flagged for immediate follow-up and lower-severity issues are grouped for periodic analysis.

11. The method of claim 1, further comprising the step of integrating the report generated from the categorized data with existing health insurance underwriting or risk management processes, thereby enabling insurers, employers, or plan sponsors to adjust premiums, plan offerings, or coverage options based on identified health trends and projected medical costs.

12. A system for collecting and processing medical and health data, comprising:
A plurality of mobile computing devices, each device being associated with a group of employees or members and running an application that installs trained large language models capable of answering medical, health, and health insurance inquiries;
A remote computing device, configured to receive, process, and analyze transmitted medical and health inquiries from the mobile computing devices, wherein the remote computing device is further configured to classify the inquiries into medical and health categories or sub-categories, and to categorize associated treatments based on cost;
A database configured to store aggregated keyword data from the medical and health inquiries, along with associated costs and trends, the database further supporting keyword ranking and trend analysis;
A reporting module configured to generate a report based on the processed data, the report including trend summaries, cost analyses, and predictive insights;
